(19) United States
(12) Patent Application Publication
(10) Pub. No.: US 2017/0367064 A1
(43) Pub. Date: Dec. 21, 2017

(54) Positioning Method and Mobile Terminal

(71) Applicant: Huawei Technologies Co., Ltd., Shenzhen (CN)

(72) Inventors: Henghui Lu, Beijing (CN); Shuiping Long, Beijing (CN); Yongxiang Liu, Shanghai (CN)

(21) Appl. No.: 15/541,177

(22) PCT Filed: Dec. 31, 2014
(86) PCT No.: PCT/CN2014/095990

§ 371 Date: Jun. 30, 2017

(51) Int. Cl. H04W 64/00; G01S 19/06; G01S 5/14

(52) U.S. Cl. CPC H04W 64/00; G01S 5/14; G01S 19/06

(57) ABSTRACT

A method includes, when a preset condition is satisfied, obtaining, by a mobile terminal, base station information of neighboring cells of a serving cell in which the mobile terminal is currently located; obtaining, by the mobile terminal, assisted global navigation satellite system (AGNSS) assistant data according to the base station information of the neighboring cells, and performing, by the mobile terminal, positioning according to the AGNSS assistant data.

### CROSS-REFERENCE TO RELATED APPLICATIONS

This application is a National Stage of International Application No. PCT/CN2014/095990, filed Dec. 31, 2014, which is hereby incorporated by reference in its entirety.

### TECHNICAL FIELD

The present disclosure relates to the field of communications technologies, and specifically relates to a positioning method and a mobile terminal.

### BACKGROUND

As an assisted global navigation satellite system (AGNSS) is characterized by quick response, high positioning precision and low power consumption, by providing AGNSS assistant data (for example, an almanac, an ephemeris, a clock or a reference location) to a global navigation satellite system (GNSS) of a mobile terminal using an AGNSS server, a positioning speed of the GNSS of the mobile terminal can be increased. The AGNSS server determines the reference location of the mobile terminal and provides the AGNSS assistant data according to the reference location and information that the AGNSS server already has such as the almanac and the ephemeris, so as to implement quick positioning. The reference location is generally determined according to a base station geographic location of a serving cell in which the mobile terminal is located, and the AGNSS server may obtain the base station geographic location by querying a base station information database. However, in an actual application, the base station information database is often incomplete, that is, a base station geographic location may not exist. For example, when a new mobile communications network (for example, 4^{th} Generation (4G) or 5^{th} Generation (5G)) is constructed, a construction speed of a base station information database may not keep pace with that of the network, resulting in a lack of a complete base station information database and a failure of AGNSS positioning.

### SUMMARY

Embodiments of the present disclosure provide a positioning method and a mobile terminal, so as to increase an AGNSS positioning success probability and enhance AGNSS robustness.

According to a first aspect, a positioning method is provided, including, when a preset condition is satisfied, obtaining, by a mobile terminal, base station information of neighboring cells of a serving cell in which the mobile terminal is currently located, where the preset condition includes a serving cell in which the mobile terminal is located in a preset network standard changes, or receives an assisted global navigation satellite system AGNSS error message; obtaining, by the mobile terminal, AGNSS assistant data according to the base station information of the neighboring cells; and performing, by the mobile terminal, positioning according to the AGNSS assistant data.

With reference to the first aspect, in a first possible implementation manner, the AGNSS error message is used to indicate that an AGNSS server has not obtained the AGNSS assistant data.

With reference to the first aspect or the first possible implementation manner of the first aspect, in a second possible implementation manner, the obtaining, by a mobile terminal, base station information of neighboring cells of a serving cell in which the mobile terminal is currently located includes obtaining, by the mobile terminal, broadcast information of the neighboring cells; and obtaining, by the mobile terminal, the base station information of the neighboring cells according to the broadcast information of the neighboring cells.

With reference to the first aspect or the first possible implementation manner of the first aspect, in a third possible implementation manner, the obtaining, by a mobile terminal, base station information of neighboring cells of a serving cell in which the mobile terminal is currently located includes obtaining, by the mobile terminal, broadcast information of the neighboring cells and signal strength information of the neighboring cells, where the signal strength information includes either a received signal strength indicator or reference signal received power; and obtaining, by the mobile terminal, the base station information of the neighboring cells according to the broadcast information of the neighboring cells and the signal strength information of the neighboring cells.

With reference to any one of the first aspect or the first to the third implementation manners of the first aspect, in a fourth possible implementation manner, the obtaining, by the mobile terminal, AGNSS assistant data according to the base station information of the neighboring cells includes sending, by the mobile terminal, a base station identifier of one of the neighboring cells to the AGNSS server; and receiving, by the mobile terminal, the AGNSS assistant data sent by the AGNSS server.

With reference to any one of the first aspect or the first to the third implementation manners of the first aspect, in a fifth possible implementation manner, the obtaining, by the mobile terminal, AGNSS assistant data according to the base station information of the neighboring cells includes obtaining, by the mobile terminal, base station geographic locations of the neighboring cells according to the base station information of the neighboring cells; determining, by the mobile terminal, a current geographic location \hat{p} of the mobile terminal according to the base station geographic locations of the neighboring cells using a K-nearest neighbor KNN algorithm, where

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

pᵢ represents a base station geographic location of an ith neighboring cell, ωᵢ represents a weight of the base station geographic location of the ith neighboring cell, and rᵢ represents strength of a signal received by the mobile terminal from a base station of the ith neighboring cell; sending, by the mobile terminal, the determined geographic location \hat{p} to the AGNSS server; and receiving, by the mobile terminal, the AGNSS assistant data sent by the AGNSS server.

With reference to any one of the first aspect or the first to the third implementation manners of the first aspect, in a sixth possible implementation manner, the obtaining, by the mobile terminal, AGNSS assistant data according to the base station information of the neighboring cells includes sending, by the mobile terminal, base station identifiers of all of the neighboring cells to the AGNSS server; and receiving, by the mobile terminal, the AGNSS assistant data sent by the AGNSS server.

According to a second aspect, a mobile terminal is provided, including a first obtaining module configured to, when a preset condition is satisfied, obtain base station information of neighboring cells of a serving cell in which the mobile terminal is currently located, where the preset condition includes a serving cell in which the mobile terminal is located in a preset network standard changes, or receives an AGNSS error message; a second obtaining module configured to obtain AGNSS assistant data according to the base station information of the neighboring cells obtained by the first obtaining module; and a positioning module configured to perform positioning according to the AGNSS assistant data obtained by the second obtaining module.

With reference to the second aspect, in a first possible implementation manner, the AGNSS error message is used to indicate that an AGNSS server has not obtained the AGNSS assistant data.

With reference to the second aspect or the first possible implementation manner of the second aspect, in a second possible implementation manner, the first obtaining module includes a first obtaining unit configured to obtain broadcast information of the neighboring cells, and obtain the base station information of the neighboring cells according to the broadcast information of the neighboring cells.

With reference to the second aspect or the first possible implementation manner of the second aspect, in a third possible implementation manner, the first obtaining module includes a second obtaining unit configured to obtain broadcast information of the neighboring cells and signal strength information of the neighboring cells, and obtain the base station information of the neighboring cells according to the broadcast information of the neighboring cells and the signal strength information of the neighboring cells, where the signal strength information includes either a received signal strength indicator or reference signal received power.

With reference to any one of the second aspect or the first to the third possible implementation manners of the second aspect, in a fourth possible implementation manner, the second obtaining module includes a first sending unit configured to send a base station identifier of one of the neighboring cells to the AGNSS server; and a first receiving unit configured to, after the first sending unit sends the base station identifier of the one of the neighboring cells to the AGNSS server, receive the AGNSS assistant data sent by the AGNSS server.

With reference to any one of the second aspect or the first to the third possible implementation manners of the second aspect, in a fifth possible implementation manner, the second obtaining module includes an obtaining unit configured to obtain base station geographic locations of the neighboring cells according to the base station information of the neighboring cells; a determining unit configured to determine, using a KNN algorithm, a current geographic location \hat{p} of the mobile terminal according to the base station geographic locations of the neighboring cells obtained by the obtaining unit, where

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

pᵢ represents a base station geographic location of an ith neighboring cell, ωᵢ represents a weight of the base station geographic location of the ith neighboring cell, and rᵢ represents strength of a signal received by the mobile terminal from a base station of the ith neighboring cell; a second sending unit configured to send the geographic location \hat{p} determined by the determining unit to the AGNSS server; and a second receiving unit configured to, after the second sending unit sends the geographic location \hat{p}, receive the AGNSS assistant data sent by the AGNSS server.

With reference to any one of the second aspect or the first to the third possible implementation manners of the second aspect, in a sixth possible implementation manner, the second obtaining module includes a third sending unit configured to send base station identifiers of all of the neighboring cells to the AGNSS server; and a third receiving unit configured to, after the third sending unit sends the base station identifiers of all of the neighboring cells to the AGNSS server, receive the AGNSS assistant data sent by the AGNSS server.

According to a third aspect, a mobile terminal is provided, including a transceiver, a memory, a processor and a bus, where the transceiver, the memory and the processor are connected to the bus; the transceiver is configured to receive or send data; and the memory is configured to store a program, and the processor is configured to invoke the program to perform the following operations: when a preset condition is satisfied, obtaining base station information of neighboring cells of a serving cell in which the mobile terminal is currently located, where the preset condition includes a serving cell in which the mobile terminal is located in a preset network standard changes, or receives an AGNSS error message; obtaining AGNSS assistant data according to the base station information of the neighboring cells; and performing positioning according to the AGNSS assistant data.

With reference to the third aspect, in a first possible implementation manner, the AGNSS error message is used to indicate that an AGNSS server has not obtained the AGNSS assistant data.

With reference to the third aspect or the first possible implementation manner of the third aspect, in a second possible implementation manner, the obtaining, by the processor, base station information of neighboring cells of a serving cell in which the mobile terminal is currently located includes obtaining, by the processor, broadcast information of the neighboring cells; and obtaining, by the processor, the base station information of the neighboring cells according to the broadcast information of the neighboring cells.

With reference to the third aspect or the first possible implementation manner of the third aspect, in a third possible implementation manner, the obtaining, by the processor, base station information of neighboring cells of a serving cell in which the mobile terminal is currently located includes obtaining, by the processor, broadcast information of the neighboring cells and signal strength information of the neighboring cells, where the signal strength information includes either a received signal strength indicator or reference signal received power; and obtaining, by the processor, the base station information of the neighboring cells according to the broadcast information of the neighboring cells and the signal strength information of the neighboring cells.

With reference to any one of the third aspect or the first to the third implementation manners of the third aspect, in a fourth possible implementation manner, the obtaining, by the processor, AGNSS assistant data according to the base station information of the neighboring cells includes sending, by the processor, a base station identifier of one of the neighboring cells to the AGNSS server; and receiving, by the processor, the AGNSS assistant data sent by the AGNSS server.

With reference to any one of the third aspect or the first to the third implementation manners of the third aspect, in a fifth possible implementation manner, the obtaining, by the processor, AGNSS assistant data according to the base station information of the neighboring cells includes obtaining, by the processor, base station geographic locations of the neighboring cells according to the base station information of the neighboring cells; determining, by the processor, a current geographic location \hat{p} of the mobile terminal according to the base station geographic locations of the neighboring cells using a K-nearest neighbor KNN algorithm, where

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

pᵢ represents a base station geographic location of an ith neighboring cell, ωᵢ represents a weight of the base station geographic location of the ith neighboring cell, and rᵢ represents strength of a signal received by the processor from a base station of the ith neighboring cell; sending, by the processor, the determined geographic location \hat{p} to the AGNSS server; and receiving, by the processor, the AGNSS assistant data sent by the AGNSS server.

With reference to any one of the third aspect or the first to the third implementation manners of the third aspect, in a sixth possible implementation manner, the obtaining, by the processor, AGNSS assistant data according to the base station information of the neighboring cells includes sending, by the processor, base station identifiers of all of the neighboring cells to the AGNSS server; and receiving, by the processor, the AGNSS assistant data sent by the AGNSS server.

It can be seen from the above that when a preset condition is satisfied, a mobile terminal obtains base station information of neighboring cells of a serving cell in which the mobile terminal is currently located; the mobile terminal obtains AGNSS assistant data according to the base station information of the neighboring cells; and the mobile terminal performs positioning according to the AGNSS assistant data. In the technical solutions of the present disclosure, after the mobile terminal fails to perform AGNSS positioning according to base station information of the serving cell in which the mobile terminal is currently located, the mobile terminal obtains the AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

### BRIEF DESCRIPTION OF DRAWINGS

FIG. 1 is a schematic diagram of an embodiment of a positioning method according to an embodiment of the present disclosure;

FIG. 2 is a schematic diagram of another embodiment of a positioning method according to an embodiment of the present disclosure;

FIG. 3 is a schematic diagram of another embodiment of a positioning method according to an embodiment of the present disclosure;

FIG. 4 is a schematic diagram of another embodiment of a positioning method according to an embodiment of the present disclosure;

FIG. 5 is a schematic diagram of another embodiment of a positioning method according to an embodiment of the present disclosure;

FIG. 6 is a schematic diagram of an embodiment of a mobile terminal according to an embodiment of the present disclosure;

FIG. 7 is a schematic diagram of another embodiment of a mobile terminal according to an embodiment of the present disclosure;

FIG. 8 is a schematic diagram of another embodiment of a mobile terminal according to an embodiment of the present disclosure;

FIG. 9 is a schematic diagram of another embodiment of a mobile terminal according to an embodiment of the present disclosure; and

FIG. 10 is a schematic structural diagram of a mobile terminal according to an embodiment of the present disclosure.

### DESCRIPTION OF EMBODIMENTS

Embodiments of the present disclosure provide a positioning method and a mobile terminal, so as to increase an AGNSS positioning success probability and enhance AGNSS robustness.

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person skilled in the art based on the embodiments of the present disclosure without creative efforts shall fall within the protection scope of the present disclosure.

The technical solutions of the present disclosure may be applied to various communications systems, such as: a Global System for Mobile Communications (GSM), a Code Division Multiple Access (CDMA) system, a Wideband Code Division Multiple Access (WCDMA), a general packet radio service (GPRS), and a Long Term Evolution (LTE).

A base station may be a base station (BTS) in the GSM or CDMA, may be a base station (NodeB) in the WCDMA, or may be an evolved NodeB (eNB or e-NodeB) in the LTE, which is not limited in the present disclosure.

A mobile terminal may be a mobile phone or a notebook, or may be an in-vehicle computer, and is not limited in the present disclosure.

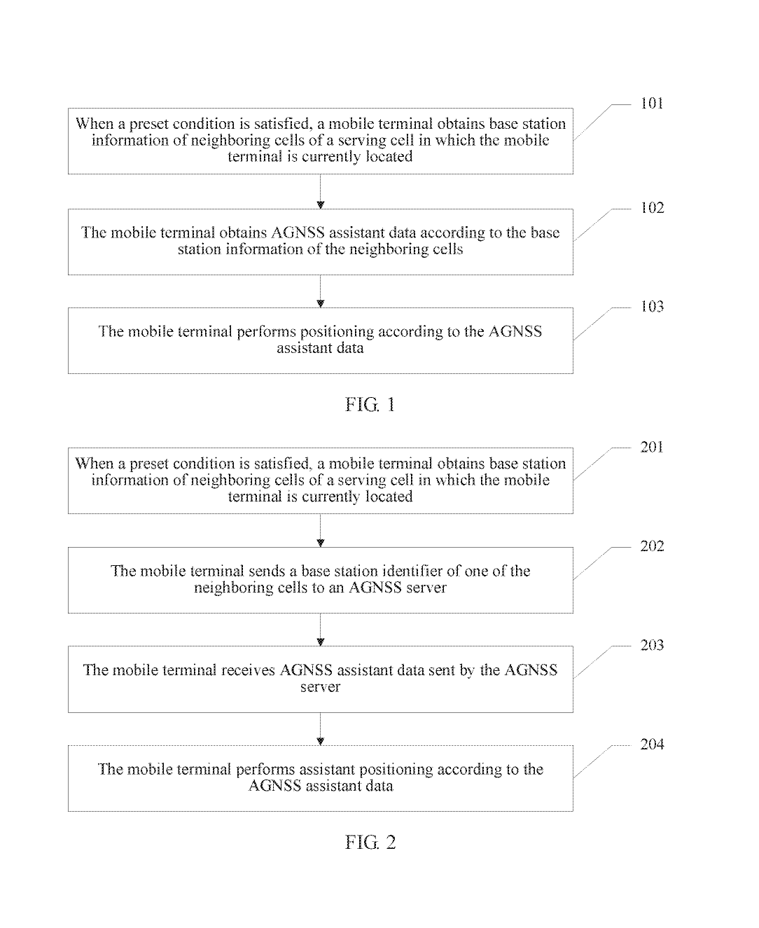

Referring to FIG. 1, an embodiment of a positioning method according to an embodiment of the present disclosure includes the following steps.

101. When a preset condition is satisfied, a mobile terminal obtains base station information of neighboring cells of a serving cell in which the mobile terminal is currently located.

In this specification, the mobile terminal is in a state in which AGNSS positioning is enabled.

In this embodiment of the present disclosure, the base station information includes but is not limited to a base station identifier, received signal strength (RSS), a mobile country code (MCC), a mobile network code (MNC) or a location area code (LAC), or the like, and is not specifically limited herein.

It should be noted that the preset condition includes a serving cell in which the mobile terminal is located in a preset network standard changes, or receives an AGNSS error message. In addition, the preset condition may include other content, and is not specifically limited herein.

102. The mobile terminal obtains AGNSS assistant data according to the base station information of the neighboring cells.

In this embodiment of the present disclosure, for a capability of the mobile terminal and different requirements on a positioning success probability, a latency, and the like, the required AGNSS assistant data may be obtained in different manners according to the base station information of the neighboring cells. The AGNSS assistant data includes at least one of an almanac, an ephemeris, a clock, a Doppler shift, a code delay, an azimuth or an elevation angle.

In this embodiment of the present disclosure, after the mobile terminal fails to perform AGNSS positioning according to base station information of the serving cell in which the mobile terminal is currently located, the mobile terminal obtains the AGNSS assistant data using the base station information of the neighboring cells. Therefore, a success probability of obtaining the AGNSS assistant data can be effectively increased, and AGNSS robustness can also be enhanced.

103. The mobile terminal performs positioning according to the AGNSS assistant data.

In this embodiment of the present disclosure, after the mobile terminal receives the AGNSS assistant data provided by an AGNSS server, a GNSS in the mobile terminal performs positioning according to information, such as a Doppler shift or a code delay, in the assistant data.

In this technical solution of the present disclosure, after a mobile terminal fails to perform AGNSS positioning according to base station information of a serving cell in which the mobile terminal is currently located, the mobile terminal obtains AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

Referring to FIG. 2, another embodiment of a positioning method according to an embodiment of the present disclosure includes the following steps.

201. When a preset condition is satisfied, a mobile terminal obtains base station information of neighboring cells of a serving cell in which the mobile terminal is currently located.

In the present disclosure, the mobile terminal is in a state in which AGNSS positioning is enabled.

It should be noted that the preset condition includes a serving cell in which the mobile terminal is located in a preset network standard changes, or receives an AGNSS error message. In addition, the preset condition may include other content, and is not specifically limited herein.

It should be noted that the preset network standard may be the Time Division-Synchronous Code Division Multiple Access (TD-SCDMA) or another 4G network standard, and is not specifically limited herein.

Optionally, the AGNSS error message is used to indicate that an AGNSS server has not obtained AGNSS assistant data.

It should be noted that the AGNSS error message received by the mobile terminal may be used to indicate another AGNSS error cause, and is not specifically limited herein.

Optionally, the obtaining, by a mobile terminal, base station information of neighboring cells of a serving cell in which the mobile terminal is currently located includes obtaining, by the mobile terminal, broadcast information of the neighboring cells; and obtaining, by the mobile terminal, the base station information of the neighboring cells according to the broadcast information of the neighboring cells.

Further, the obtaining, by a mobile terminal, base station information of neighboring cells of a serving cell in which the mobile terminal is currently located includes obtaining, by the mobile terminal, broadcast information of the neighboring cells and signal strength information of the neighboring cells, where the signal strength information includes either a received signal strength indicator or reference signal received power; and obtaining, by the mobile terminal, the base station information of the neighboring cells according to the broadcast information of the neighboring cells and the signal strength information of the neighboring cells.

202. The mobile terminal sends a base station identifier of one of the neighboring cells to an AGNSS server.

It should be noted that the neighboring cells are arranged based on priorities, and the neighboring cells may be arranged based on priorities according to a status of a base station information database, base station signal strength, and the like, which is not specifically limited herein.

In this embodiment of the present disclosure, for example, for the first time, a base station identifier of a neighboring cell having a highest priority may be sent to the AGNSS server. If the mobile terminal fails to receive AGNSS assistant data, a base station identifier of a neighboring cell whose priority ranks next is sent to the AGNSS server. The process is repeated until the mobile terminal successfully receives AGNSS assistant data.

203. The mobile terminal receives AGNSS assistant data sent by the AGNSS server.

In this embodiment of the present disclosure, after the mobile terminal fails to perform AGNSS positioning according to base station information of the serving cell in which the mobile terminal is currently located, the mobile terminal obtains the AGNSS assistant data using the base station information of the neighboring cells. Therefore, an AGNSS positioning success probability can be effectively increased, and AGNSS robustness can also be enhanced.

204. The mobile terminal performs positioning according to the AGNSS assistant data.

In this embodiment of the present disclosure, after the mobile terminal receives the AGNSS assistant data provided by the AGNSS server, a GNSS in the mobile terminal performs satellite searching and positioning according to information, such as a Doppler shift or a code delay, in the assistant data.

In this technical solution of the present disclosure, after a mobile terminal fails to perform AGNSS positioning according to base station information of a serving cell in which the mobile terminal is currently located, the mobile terminal obtains AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

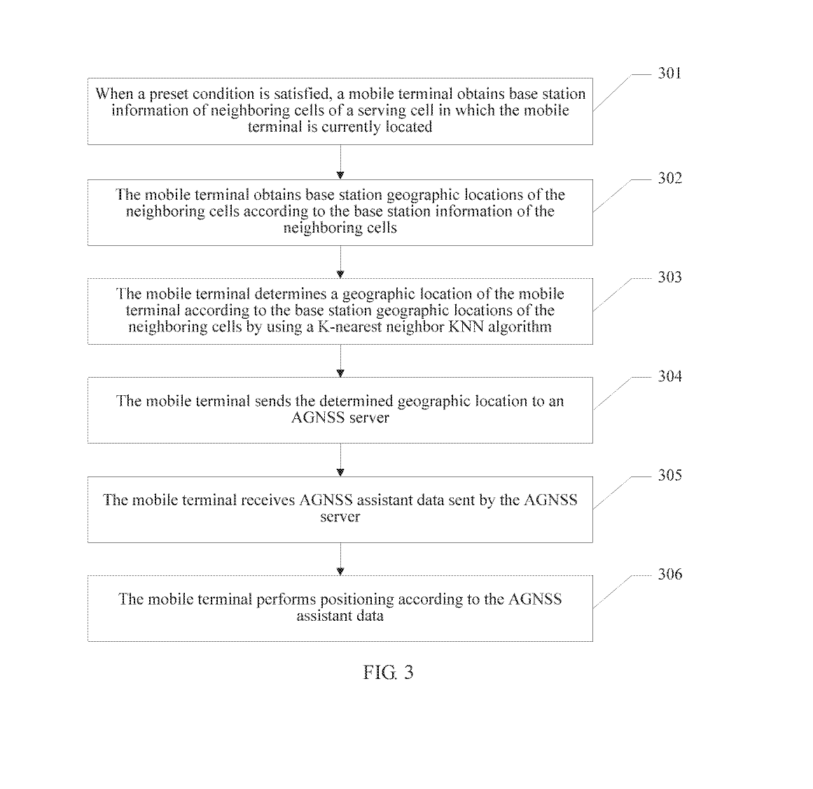

Referring to FIG. 3, another embodiment of a positioning method according to an embodiment of the present disclosure includes the following steps.

301. When a preset condition is satisfied, a mobile terminal obtains base station information of neighboring cells of a serving cell in which the mobile terminal is currently located.

For details of this embodiment of the present disclosure, refer to step 201 of the embodiment in FIG. 2.

302. The mobile terminal obtains base station geographic locations of the neighboring cells according to the base station information of the neighboring cells.

It should be noted that the base station geographic locations of the neighboring cells may be directly extracted from broadcast information (for example, in a CDMA network), or may be obtained using a Cell-ID positioning method from a base station information database stored in a third party or in the mobile terminal, which is not specifically limited herein.

303. The mobile terminal determines a current geographic location \hat{p} of the mobile terminal according to the base station geographic locations of the neighboring cells using a K-nearest neighbor KNN algorithm.

In this embodiment of the present disclosure,

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

where pᵢ represents a base station geographic location of an ith neighboring cell; ωᵢ represents a weight of the base station geographic location of the ith neighboring cell, and rᵢ represents strength of a signal received by the mobile terminal from a base station of the ith neighboring cell.

304. The mobile terminal sends the determined geographic location \hat{p} to an AGNSS server.

In this embodiment of the present disclosure, different from the embodiment corresponding to FIG. 2, the current geographic location \hat{p} of the mobile terminal is sent to the AGNSS server.

305. The mobile terminal receives AGNSS assistant data sent by the AGNSS server.

306. The mobile terminal performs positioning according to the AGNSS assistant data.

In this technical solution of the present disclosure, after a mobile terminal fails to perform AGNSS positioning according to base station information of a serving cell in which the mobile terminal is currently located, the mobile terminal obtains AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

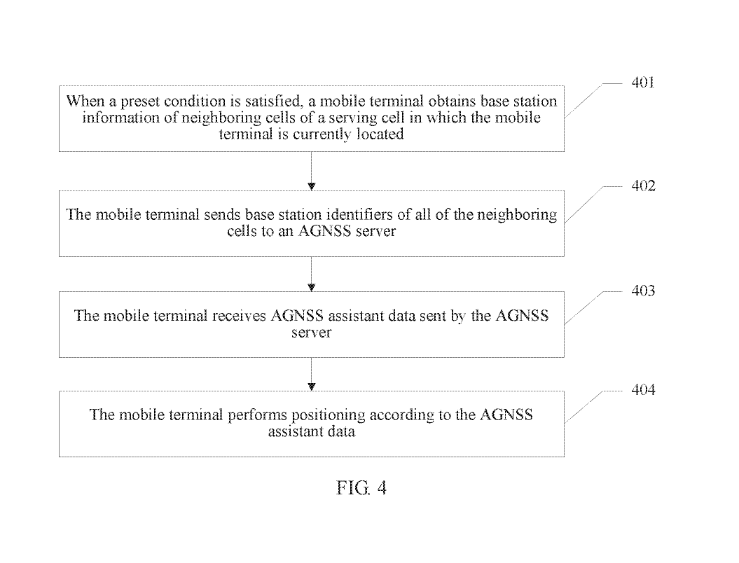

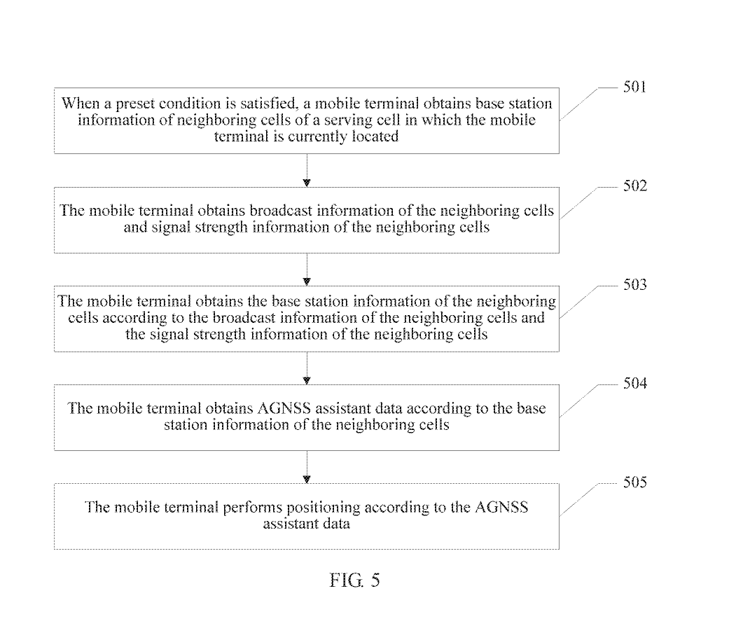

Referring to FIG. 4, another embodiment of a positioning method according to an embodiment of the present disclosure includes the following steps.

401. When a preset condition is satisfied, a mobile terminal obtains base station information of neighboring cells of a serving cell in which the mobile terminal is currently located.

For details of this embodiment of the present disclosure, refer to step 201 of the embodiment in FIG. 2.

402. The mobile terminal sends base station identifiers of all of the neighboring cells to an AGNSS server.

In this embodiment of the present disclosure, the base station identifiers of all of the neighboring cells include base station identifiers of all neighboring cells of a same standard and neighboring cells of different standards, so that the AGNSS server provides corresponding AGNSS assistant data according to the base station identifiers of all the neighboring cells.

In this embodiment of the present disclosure, different from the embodiment corresponding to FIG. 3, the base station identifiers of all of the neighboring cells are sent to the AGNSS server.

403. The mobile terminal receives AGNSS assistant data sent by the AGNSS server.

403. The mobile terminal performs positioning according to the AGNSS assistant data.

In this technical solution of the present disclosure, after a mobile terminal fails to perform AGNSS positioning according to base station information of a serving cell in which the mobile terminal is currently located, the mobile terminal obtains AGNSS assistant data using the base station information of neighboring cells. Therefore, compared with the prior art in which only the base station information of the current serving cell is used, an AGNSS positioning success probability can be effectively increased, and AGNSS robustness can also be enhanced.

Referring to FIG. 5, an embodiment of a specific application scenario of a positioning method according to an embodiment of the present disclosure includes the following steps.

501. When a preset condition is satisfied, a mobile terminal obtains base station information of neighboring cells of a serving cell in which the mobile terminal is currently located.

For details of this embodiment of the present disclosure, refer to step 201 of the embodiment in FIG. 2.

502. The mobile terminal obtains broadcast information of the neighboring cells and signal strength information of the neighboring cells.

In this embodiment of the present disclosure, the mobile terminal listens to broadcast information of the serving cell in which the mobile terminal is currently located, and extracts frequencies of the neighboring cells from system information blocks (SIB) in the broadcast information. The mobile terminal listens to broadcast information of the neighboring cells at the frequencies of the neighboring cells, and measures signal strength of the neighboring cells, so as to obtain signal strength information of the neighboring cells.

In this embodiment of the present disclosure, the signal strength information includes either a received signal strength indicator or reference signal received power.

503. The mobile terminal obtains the base station information of the neighboring cells according to the broadcast information of the neighboring cells and the signal strength information of the neighboring cells.

It should be noted that, optionally, the mobile terminal obtains the base station information of the neighboring cells according to the broadcast information of the neighboring cells, which is not specifically limited herein.

504. The mobile terminal obtains AGNSS assistant data according to the base station information of the neighboring cells.

Optionally, the obtaining, by the mobile terminal, AGNSS assistant data according to the base station information of the neighboring cells includes sending, by the mobile terminal, a base station identifier of one of the neighboring cells to an AGNSS server; and receiving, by the mobile terminal, the AGNSS assistant data sent by the AGNSS server.

In this embodiment of the present disclosure, the neighboring cells are arranged based on priorities. For example, for the first time, a base station identifier of a neighboring cell having a highest priority may be sent to the AGNSS server. If the mobile terminal fails to receive the AGNSS assistant data, a base station identifier of a neighboring cell whose priority ranks next is sent to the AGNSS server. The process is repeated until the mobile terminal successfully receives the AGNSS assistant data.

It should be noted that the neighboring cells may be arranged based on priorities according to a status of a base station database, base station signal strength, and the like, which is not specifically limited herein.

Optionally, the obtaining, by the mobile terminal, AGNSS assistant data according to the base station information of the neighboring cells includes obtaining, by the mobile terminal, base station geographic locations of the neighboring cells according to the base station information of the neighboring cells; determining, by the mobile terminal, a current geographic location \hat{p} of the mobile terminal according to the base station geographic locations of the neighboring cells using a KNN algorithm, where

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

Pᵢ represents a base station geographic location of an ith neighboring cell, ωᵢ represents a weight of the base station geographic location of the ith neighboring cell, and rᵢ represents strength of a signal received by the mobile terminal from a base station of the ith neighboring cell; sending, by the mobile terminal, the determined geographic location \hat{p} to the AGNSS server; and receiving, by the mobile terminal, the AGNSS assistant data sent by the AGNSS server.

It should be noted that the base station geographic locations of the neighboring cells may be directly extracted from the broadcast information (for example, in a CDMA network), or may be obtained using a Cell-ID positioning method from a base station information database stored in a third party or in the mobile terminal, which is not specifically limited herein.

Optionally, the obtaining, by the mobile terminal, AGNSS assistant data according to the base station information of the neighboring cells includes sending, by the mobile terminal, base station identifiers of all of the neighboring cells to the AGNSS server; and receiving, by the mobile terminal, the AGNSS assistant data sent by the AGNSS server.

In this embodiment of the present disclosure, the base station identifiers of all of the neighboring cells include base station identifiers of all neighboring cells of a same standard and neighboring cells of different standards, so that the AGNSS server provides corresponding AGNSS assistant data according to the base station identifiers of all the neighboring cells.

505. The mobile terminal performs positioning according to the AGNSS assistant data.

In this technical solution of the present disclosure, after a mobile terminal fails to perform AGNSS positioning according to base station information of a serving cell in which the mobile terminal is currently located, the mobile terminal obtains AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

For the convenience of implementing the foregoing related method in the embodiments of the present disclosure, the following further provides a related terminal configured to implement the foregoing method.

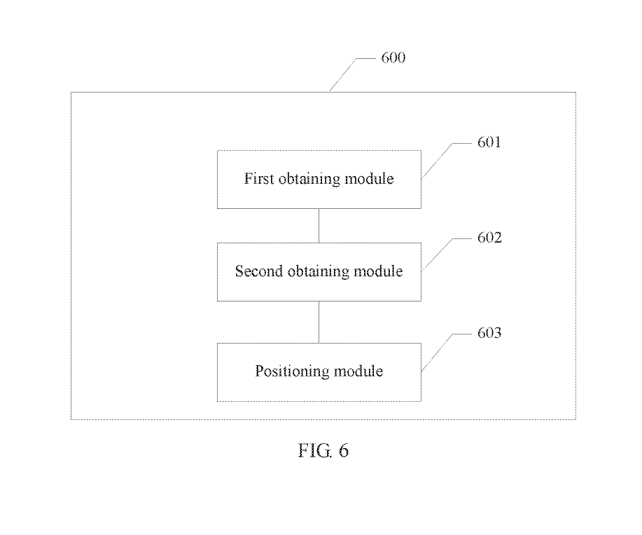

Referring to FIG. 6, an embodiment of a mobile terminal 600 according to an embodiment of the present disclosure includes a first obtaining module 601, a second obtaining module 602 and a positioning module 603, where the first obtaining module 601 is configured to, when a preset condition is satisfied, obtain base station information of neighboring cells of a serving cell in which the mobile terminal is currently located, where the preset condition includes a serving cell in which the mobile terminal is located in a preset network standard changes, or receives an AGNSS error message; the second obtaining module 602 is configured to obtain AGNSS assistant data according to the base station information of the neighboring cells obtained by the first obtaining module 601; and the positioning module 603 is configured to perform positioning according to the AGNSS assistant data obtained by the second obtaining module 602.

In this technical solution of the present disclosure, after the mobile terminal fails to perform AGNSS positioning according to base station information of a serving cell in which the mobile terminal is currently located, the mobile terminal obtains AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

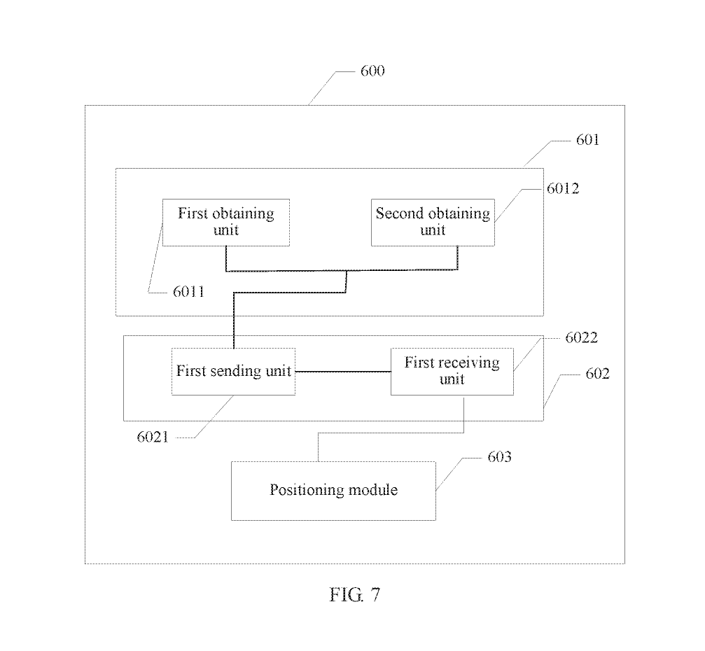

Referring to FIG. 7, optionally, the AGNSS error message is used to indicate that an AGNSS server has not obtained the AGNSS assistant data.

Optionally, the first obtaining module 601 includes a first obtaining unit 6011, where the first obtaining unit 6011 is configured to obtain broadcast information of the neighboring cells, and obtain the base station information of the neighboring cells according to the broadcast information of the neighboring cells.

Optionally, the first obtaining module 601 includes a second obtaining unit 6012, where the second obtaining unit 6012 is configured to obtain broadcast information of the neighboring cells and signal strength information of the neighboring cells, and obtain the base station information of the neighboring cells according to the broadcast information of the neighboring cells and the signal strength information of the neighboring cells, where the signal strength information includes either a received signal strength indicator or reference signal received power.

Optionally, the second obtaining module 602 includes a first sending unit 6021 and a first receiving unit 6022, where the first sending unit 6021 is configured to send a base station identifier of one of the neighboring cells to the AGNSS server; and the first receiving unit 6022 is configured to, after the first sending unit 6021 sends the base station identifier of the one of the neighboring cells to the AGNSS server, receive the AGNSS assistant data sent by the AGNSS server.

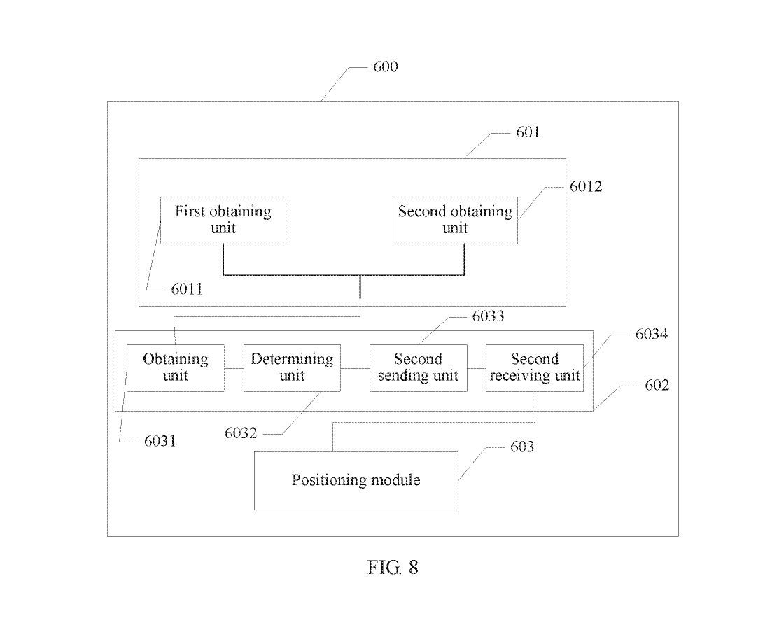

Referring to FIG. 8, optionally, the AGNSS error message is used to indicate that an AGNSS server has not obtained the AGNSS assistant data.

Optionally, the first obtaining module 601 includes a first obtaining unit 6011, where the first obtaining unit 6011 is configured to obtain broadcast information of the neighboring cells, and obtain the base station information of the neighboring cells according to the broadcast information of the neighboring cells.

Optionally, the first obtaining module 601 includes a second obtaining unit 6012, where the second obtaining unit 6012 is configured to obtain broadcast information of the neighboring cells and signal strength information of the neighboring cells, and obtain the base station information of the neighboring cells according to the broadcast information of the neighboring cells and the signal strength information of the neighboring cells, where the signal strength information includes either a received signal strength indicator or reference signal received power.

Optionally, the second obtaining module 602 includes a first obtaining unit 6031, a determining unit 6032, a second sending unit 6033 and a second receiving unit 6034, where the first obtaining unit 6031 is configured to obtain base station geographic locations of the neighboring cells according to the base station information of the neighboring cells; the determining unit 6032 is configured to determine, using a KNN algorithm, a current geographic location \hat{p} of the mobile terminal according to the base station geographic locations of the neighboring cells obtained by the obtaining unit 6031, where

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

pᵢ represents a base station geographic location of an ith neighboring cell, ωᵢ represents a weight of the base station geographic location of the ith neighboring cell, and rᵢ represents strength of a signal received by the mobile terminal from a base station of the ith neighboring cell; the second sending unit 6033 is configured to send the geographic location \hat{p} determined by the determining unit 6032 to the AGNSS server; and the second receiving unit 6034 is configured to, after the second sending unit 6033 sends the geographic location \hat{p}, receive the AGNSS assistant data sent by the AGNSS server.

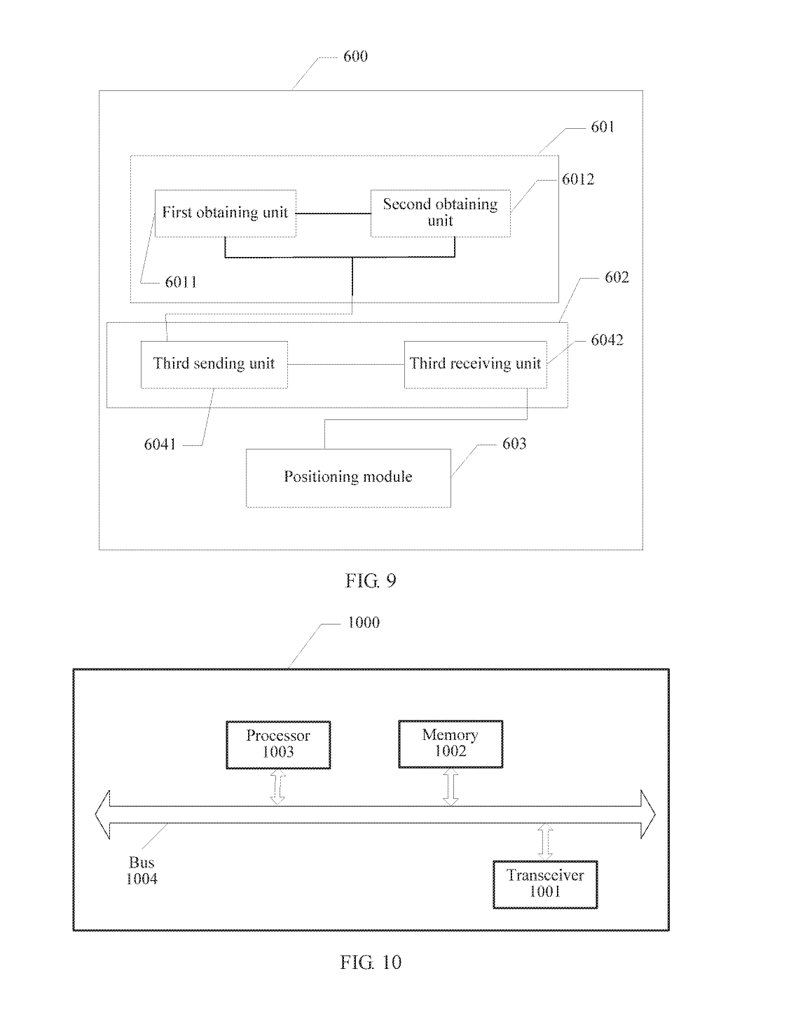

Referring to FIG. 9, optionally, the AGNSS error message is used to indicate that an AGNSS server has not obtained the AGNSS assistant data.

Optionally, the first obtaining module 601 includes a first obtaining unit 6011, where the first obtaining unit 6011 is configured to obtain broadcast information of the neighboring cells, and obtain the base station information of the neighboring cells according to the broadcast information of the neighboring cells.

Optionally, the first obtaining module 601 includes a second obtaining unit 6012, where the second obtaining unit 6012 is configured to obtain broadcast information of the neighboring cells and signal strength information of the neighboring cells, and obtain the base station information of the neighboring cells according to the broadcast information of the neighboring cells and the signal strength information of the neighboring cells, where the signal strength information includes either a received signal strength indicator or reference signal received power; the second obtaining module 602 is configured to obtain AGNSS assistant data according to the base station information of the neighboring cells obtained by the first obtaining module 601; and the second obtaining module 602 includes a third sending unit 6041 and a third receiving unit 6042, where the third sending unit 6041 is configured to send base station identifiers of all of the neighboring cells to an AGNSS server; and the third receiving unit 6042 is configured to, after the third sending unit 6041 sends the base station identifiers of all of the neighboring cells to the AGNSS server, receive the AGNSS assistant data sent by the AGNSS server.

The embodiments shown in FIG. 6 to FIG. 9 describe a specific structure of the mobile terminal from the perspective of functional modules, and the following describes a specific structure of a mobile terminal from the perspective hardware using an embodiment in FIG. 10.

Referring to FIG. 10, FIG. 10 is a schematic structural diagram of a mobile terminal 1000 according to an embodiment of the present disclosure, including a transceiver 1001, a memory 1002, a processor 1003 and a bus 1004, where the transceiver 1001, the memory 1002 and the processor 1003 are connected to the bus 1004; the transceiver 1001 is configured to receive or send data; and the memory 1002 is configured to store a program, and the processor 1003 is configured to invoke the program to perform the following operations, when a preset condition is satisfied, obtaining base station information of neighboring cells of a serving cell in which the mobile terminal is currently located, where the preset condition includes a serving cell in which the mobile terminal is located in a preset network standard changes, or receives an AGNSS error message; obtaining AGNSS assistant data according to the base station information of the neighboring cells; and performing positioning according to the AGNSS assistant data.

Optionally, the AGNSS error message is used to indicate that an AGNSS server has not obtained the AGNSS assistant data.

Optionally, the obtaining, by the processor, base station information of neighboring cells of a serving cell in which the mobile terminal is currently located includes obtaining, by the processor, broadcast information of the neighboring cells; and obtaining, by the processor, the base station information of the neighboring cells according to the broadcast information of the neighboring cells.

Optionally, the obtaining, by the processor, base station information of neighboring cells of a serving cell in which the mobile terminal is currently located includes obtaining, by the processor, broadcast information of the neighboring cells and signal strength information of the neighboring cells, where the signal strength information includes either a received signal strength indicator or reference signal received power; and obtaining, by the processor, the base station information of the neighboring cells according to the broadcast information of the neighboring cells and the signal strength information of the neighboring cells.

Optionally, the obtaining, by the processor, AGNSS assistant data according to the base station information of the neighboring cells includes sending, by the processor, a base station identifier of one of the neighboring cells to the AGNSS server; and receiving, by the processor, the AGNSS assistant data sent by the AGNSS server.

Optionally, the obtaining, by the processor, AGNSS assistant data according to the base station information of the neighboring cells includes obtaining, by the processor, base station geographic locations of the neighboring cells according to the base station information of the neighboring cells; determining, by the processor, a current geographic location \hat{p} of the mobile terminal according to the base station geographic locations of the neighboring cells using a K-nearest neighbor KNN algorithm, where

$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$

pᵢ represents a base station geographic location of an ith neighboring cell, ωᵢ represents a weight of the base station geographic location of the ith neighboring cell, and rᵢ represents strength of a signal received by the processor from a base station of the ith neighboring cell; sending, by the processor, the determined geographic location \hat{p} to the AGNSS server; and receiving, by the processor, the AGNSS assistant data sent by the AGNSS server.

Optionally, the obtaining, by the processor, AGNSS assistant data according to the base station information of the neighboring cells includes sending, by the processor, base station identifiers of all of the neighboring cells to the AGNSS server; and receiving, by the processor, the AGNSS assistant data sent by the AGNSS server.

It should be noted that, in the foregoing embodiments, the descriptions of the embodiments have their respective focuses. For a part that is not described in detail in an embodiment, refer to related descriptions in other embodiments. For example, for a part that is not described in detail in the embodiment in FIG. 10, refer to related descriptions in the positioning method embodiments or the mobile terminal embodiments in FIG. 1 to FIG. 9.

It can be seen from the above that in this embodiment of the present disclosure, when a preset condition is satisfied, the mobile terminal obtains base station information of neighboring cells of a serving cell in which the mobile terminal is currently located; the mobile terminal obtains AGNSS assistant data according to the base station information of the neighboring cells; and the mobile terminal performs positioning according to the AGNSS assistant data. In the technical solutions of the present disclosure, after the mobile terminal fails to perform AGNSS positioning according to base station information of the serving cell in which the mobile terminal is currently located, the mobile terminal obtains the AGNSS assistant data using the base station information of the neighboring cells. Therefore, compared with the prior art in which only the base station information of the current serving cell is used, an AGNSS positioning success probability can be effectively increased, and AGNSS robustness can also be enhanced.

In the several embodiments provided in the present application, it should be understood that the disclosed apparatus and method may be implemented in other manners. For example, the described apparatus embodiment is merely an example. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented using some interfaces. Indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. Integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or some of the technical solutions may be implemented in the form of a software product. The computer software product is stored in a storage medium and includes several instructions for instructing a computer device (which may be a personal computer, a server, or a network device, or the like) to perform all or some of the steps of the methods described in the embodiments of the present disclosure. The foregoing storage medium includes any medium that can store a program code, such as a universal serial bus (USB) flash drive, a removable hard disk, a read-only memory (ROM), a random access memory (RAM), a magnetic disk, or an optical disc.

The foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1.-21. (canceled)

22. A positioning method, comprising:
obtaining, by a mobile terminal, base station information of neighboring of a serving cell in which the mobile terminal is currently located when a preset condition is satisfied, wherein the preset condition comprises a changing of a serving cell in which the mobile terminal is located in a preset network standard, or the mobile terminal receives an assisted global navigation satellite system (AGNSS) error message;
obtaining, by the mobile terminal, AGNSS assistant data according to the base station information of the neighboring cells; and
performing, by the mobile terminal, positioning according to the AGNSS assistant data.

23. The positioning method according to claim 22, wherein the AGNSS error message is used to indicate that an AGNSS server has not obtained the AGNSS assistant data.

24. The positioning method according to claim 22, wherein obtaining, by the mobile terminal, the base station information of the neighboring cells of the serving cell in which the mobile terminal is currently located comprises:
obtaining, by the mobile terminal, broadcast information of the neighboring cells; and
obtaining, by the mobile terminal, the base station information of the neighboring cells according to the broadcast information of the neighboring cells.

25. The positioning method according to claim 22, wherein obtaining, by the mobile terminal, the base station information of the neighboring cells of the serving cell in which the mobile terminal is currently located comprises:
obtaining, by the mobile terminal, broadcast information of the neighboring cells and signal strength information of the neighboring cells, wherein the signal strength information comprises either a received signal strength indicator or reference signal received power; and
obtaining, by the mobile terminal, the base station information of the neighboring cells according to the broadcast information of the neighboring cells and the signal strength information of the neighboring cells.

26. The positioning method according to claim 22, wherein obtaining, by the mobile terminal, the AGNSS assistant data according to the base station information of the neighboring cells comprises:
sending, by the mobile terminal, a base station identifier of one of the neighboring cells to the AGNSS server; and
receiving, by the mobile terminal, the AGNSS assistant data from the AGNSS server.

27. The positioning method according to claim 22, wherein obtaining, by the mobile terminal, the AGNSS assistant data according to the base station information of the neighboring cells comprises:
obtaining, by the mobile terminal, base station geographic locations of the neighboring cells according to the base station information of the neighboring cells;
determining, by the mobile terminal, a current geographic location \hat{p} of the mobile terminal according to the base station geographic locations of the neighboring cells by using a K-nearest neighbor KNN algorithm, wherein
$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$
wherein pᵢ represents a base station geographic location of an i^{th} neighboring cell, wherein ωᵢ represents a weight of the base station geographic location of the i^{th} neighboring cell, and wherein rᵢ represents strength of a signal received by the mobile terminal from a base station of the i^{th} neighboring cell;
sending, by the mobile terminal, the current geographic location \hat{p} to the AGNSS server; and
receiving, by the mobile terminal, the AGNSS assistant data from the AGNSS server.

28. The positioning method according to claim 22, wherein obtaining, by the mobile terminal, the AGNSS assistant data according to the base station information of the neighboring cells comprises:
sending, by the mobile terminal, base station identifiers of all of the neighboring cells to the AGNSS server; and
receiving, by the mobile terminal, the AGNSS assistant data from the AGNSS server.

29. A mobile terminal, comprising:
a transceiver configured to receive or send data;
a memory configured to store a program;
a processor; and
a bus coupled to the transceiver, the memory and the processor,
wherein the processor is configured to:
obtain base station information of neighboring cells of a serving cell in which the mobile terminal is currently located when a preset condition is satisfied, wherein the preset condition comprises changing a serving cell in which the mobile terminal is located in a preset network standard, or the mobile terminal receives an assisted global navigation satellite system (AGNSS) error message;
obtain AGNSS assistant data according to the base station information of the neighboring cells; and
perform positioning according to the AGNSS assistant data.

30. The mobile terminal according to claim 29, wherein the AGNSS error message is used to indicate that an AGNSS server has not obtained the AGNSS assistant data.

31. The mobile terminal according to claim 29, wherein obtaining, by the processor, the base station information of the neighboring cells of the serving cell in which the mobile terminal is currently located comprises:
obtaining, by the processor, broadcast information of the neighboring cells; and
obtaining, by the processor, the base station information of the neighboring cells according to the broadcast information of the neighboring cells.

32. The mobile terminal according to claim 29, wherein obtaining, by the processor, the base station information of the neighboring cells of the serving cell in which the mobile terminal is currently located comprises:
obtaining, by the processor, broadcast information of the neighboring cells and signal strength information of the neighboring cells, wherein the signal strength information comprises either a received signal strength indicator or reference signal received power; and
obtaining, by the processor, the base station information of the neighboring cells according to the broadcast information of the neighboring cells and the signal strength information of the neighboring cells.

33. The mobile terminal according to claim 29, wherein obtaining, by the processor, the AGNSS assistant data according to the base station information of the neighboring cells comprises:
sending, by the processor, a base station identifier of one of the neighboring cells to the AGNSS server; and
receiving, by the processor, the AGNSS assistant data from the AGNSS server.

34. The mobile terminal according to claim 29, wherein obtaining, by the processor, the AGNSS assistant data according to the base station information of the neighboring cells comprises:
obtaining, by the processor, base station geographic locations of the neighboring cells according to the base station information of the neighboring cells;
determining, by the processor, a current geographic location \hat{p} of the mobile terminal according to the base station geographic locations of the neighboring cells by using a K-nearest neighbor KNN algorithm, wherein
$$\hat{p} = {\sum }_{i = 1}^{N} {ω}_{i} {p}_{i} , {ω}_{i} = \frac{{r}_{i}}{{\sum }_{i = 1}^{N} {r}_{i}} ,$$
wherein pᵢ represents a base station geographic location of an i^{th} neighboring cell, wherein ωᵢ represents a weight of the base station geographic location of the i^{th} neighboring cell, and wherein rᵢ represents strength of a signal received by the processor from a base station of the i^{th} neighboring cell;
sending, by the processor, the current geographic location \hat{p} to the AGNSS server; and
receiving, by the processor, the AGNSS assistant data from the AGNSS server.

35. The mobile terminal according to claim 29, wherein obtaining, by the processor, the AGNSS assistant data according to the base station information of the neighboring cells comprises:
sending, by the processor, base station identifiers of all of the neighboring cells to the AGNSS server; and
receiving, by the processor, the AGNSS assistant data from the AGNSS server.
